(19) United States
(12) Patent Application Publication
(10) Pub. No.: US 2007/0180359 A1
(43) Pub. Date: Aug. 2, 2007

(54) Method of and apparatus for preparing a document for display or printing

(76) Inventor: Fabio Giannetti, Bristol (GB)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/342,832

(22) Filed: Jan. 31, 2006

(51) Int. Cl. G06F 17/00

(52) U.S. Cl. 715/513; 715/517

(57) ABSTRACT

A method is provided for facilitating the re-use of documents. The content, appearance and layout of the document are stored separately such that each can be manipulated or altered independently of the others.

### RELATED APPLICATIONS

The present application is based on, and claims priority from, GB Application Number 0501885.8, filed Jan. 31, 2005, the disclosure of which is hereby incorporated by reference herein in its entirety.

### FIELD OF THE INVENTION

The present invention relates to a method of and apparatus for preparing a document for display or printing.

### BACKGROUND OF THE INVENTION

In document publishing, both for digital and paper publishing, a document is often produced as a series of process steps. An author, for example a journalist, defines the data content of the document, that is the text, images and other content to be included within the document. The non-textual contents of the document are referred to as “assets” of the document. This typically means images within the document, but in the era of digital delivery assets may also represent moving images, sound files and downloadable content. The data content is then passed to a graphic designer who arranges the data content on a page, thus defining a layout for the data content. The graphic designer will also define aspects of appearance, e.g. of style and format for the data content, such as font, text size and so on. The document can then be published. In prior art publishing systems the finalised document is “monolithic” in that the finished product is stored as a single entity.

The graphic design stage is often time-consuming as it is often particularly important for a document publisher to ensure that a published document is aesthetically pleasing to a reader, as this may have an impact on the decisions to make a repeat purchase of, for example, a magazine. The fact that prior art systems store the finished page as a single entity makes it difficult for publishers to re-use content without having to re-employ the skills of the graphic designer.

As used herein, “layout” and “layout information” refers to information about how data content is to be physically placed on a page, whereas “appearance” and “appearance information” refers to how the data content should appear and be formatted, for example by specifying text font and size, colour and so on.

According to a first aspect of the present invention there is provided a method of preparing a document for distribution, display or printing, where the document is defined by: data content; appearance information defining an appearance to be applied to the data content; and layout information defining a layout to be applied to the data content; and where the data content is distinct from the layout information and the appearance information, the method comprising an input step where the data content, appearance information and layout information are made available to a data processor, and a processing step where the appearance information and layout information are applied to the data content so as to produce an electronic representation of the document.

Thus a method is provided which allows the data content to be amended in part or in its entirety prior to a point when it is desired to finalise the document, i.e. to combine the data content the appearance information and the layout information. The layout only needs to be determined once. Therefore when the data content is amended, the graphic designer does not have to redefine the layout and hence need not be involved in the amendment process. The document can therefore be finalised more quickly. Alternatively or at the same time, the appearance (i.e. appearance of the data content) can be amended without redefining the layout. This enables semi-automatic or automatic re-use of the data content or the “look and feel” of a document.

Once an electronic representation of the document has been produced it may be output or saved, possibly after format conversion, in a form suitable for subsequent use. Thus a document may be saved in a format suitable for printing. The saved document may then be transmitted to a printer for printing. The printer may be a digital printer used for commercial printing.

There are many reasons why it may be desirable to amend the data content. For example, if data content to be published should include information as to the date of publication or the name or other information relating to the intended recipient or recipients, such information can be included within the published document without further intervention from the graphic designer. Similarly an editor may wish to edit parts of the data content. Certain assets can be replaced by others, for example an image to be included within the published document can be substituted by an alternative image, and/or the data content (or a text portion thereof) could be replaced with the same text in a different language, or a different text entirely.

Preferably the data content, appearance information and layout information are available as electronic files. These are read during the method according to the invention to acquire their contents. Alternatively the data content may be provided “live” by being typed by a user during use of the method.

Preferably at least one of the data content and the appearance information is in a non-proprietory format, and advantageously is in a format which is XML-compliant, i.e. compliant with an XML standard. XML is a widely-used standard and its use improves the integration of the present invention with existing technology as several existing XML editors and processors can be used to amend XML-compliant files. Advantageously the layout information may also be represented in a non-proprietory, for example an XML-compliant, format.

The appearance information is preferably considered as separate formatting and style information. The style information specifies a number of chosen styles, and may specify font, font size, text orientation and the like. The formatting information specifies which styles apply to specific parts of the data content for example styles to be applied to titles and paragraphs. The formatting information may also specify the margins on the page, header and footer and other page properties. This is distinct from the layout which concerns the physical placement of the data content on a page. A page may include physical pages such as A4 or letter-sized paper, or electronic pages such as web pages and PDF files.

Preferably the style information is represented in an XML-compliant language such as XSLT, and the formatting information is a mixture of XML-compliant languages XSLT and XSL-FO. Various other representations can be used and do not have to be XML-based. For example the style information may be in cascading style sheets, (CSS) format which is a non-XML-compliant language commonly used to specify styles for web pages as of September 2004.

The finalised document suitable for display or printing is preferably represented in one of a number of currently widely-available formats. Examples of these include XML-compliant formats such as Personalised Printer Mark-up Language (PPML), Scalable Vector Graphic (SVG) or XML-FO. Other non-XML-compliant formats could be used such as PDF or HTML. A number of currently available rendering programs can render the document appropriately for display on a screen and/or sending to a printer.

Advantageously the method may allow a user to define batch processing operations in which a plurality of appearances and layouts are applied to be a selected data content. This is useful where a publisher has several titles (e.g. papers or magazines) and each has a respective “look and feel” but where the publisher wishes to re-use the same data content, for example an article, in each title. The method according to the present invention can systematically apply the different appearances and layouts to the same data, thereby allowing the content of the various titles to be easily and automatically generated from the initial data content.

Similarly where a family of titles has the same “look and feel” but is distributed in different languages the method according to the invention can be used to automatically apply the same look and feel to different data contents (e.g. different language versions of the text).

According to a second aspect of the present invention there is provided an apparatus for preparing a document for distribution, display or printing, wherein the document is defined by: data content; appearance information defining an appearance to be applied to the data content; and layout information defining a layout to be applied to the data content, wherein the apparatus comprises a data processor arranged to receive the data content, the appearance information and the layout information, and to apply the layout information so as to produce an electronic representation of the document.

According to a third aspect of the invention there is provided a method of storing a document, comprising the steps of storing data content of the document in a data file, storing information relating to layout of the data content in a layout file, and storing information relating to appearance of the data content in at least one appearance information file.

According to a fourth aspect of the present invention there is provided a method of parsing a document comprising the steps of:

reading an electronic representation of a document;

processing the document so as to identify the textual content of the document and saving the textual content of the document to a data file;

processing the document so as to identify layout information and saving the layout information to a layout file; and

processing the document so as to identify appearance information and saving the appearance information to at least one appearance information file.

According to a fifth aspect of the present invention there is provided a computer program for causing a programmable data processor to implement the method defined in claim 1.

### BRIEF DESCRIPTION OF THE DRAWINGS

The invention will now be described, by way of example only, with reference to the accompanying figures, in which:

FIG. 1 shows an example of a document;

FIG. 2 schematically shows an example of a document split into component parts;

FIG. 3 shows an example of text content;

FIG. 4 shows an example of style information;

FIG. 5 shows an example of formatting information;

FIG. 6 shows an example of formatted text;

FIG. 7 schematically shows an example of a process according to an embodiment of the present invention;

FIG. 8 shows an example of alternative text content to that shown in FIG. 3;

FIG. 9 schematically shows the example process of FIG. 7 when using the alternative text content;

FIG. 10 schematically shows the example process of FIG. 7 when using an alternative image;

FIG. 11 shows a portion of a document including the alternative image;

FIG. 12 schematically shows the process of FIG. 10 when using an alternative layout;

FIG. 13 shows a portion of a document including the alternative image and the alternative layout; and

FIG. 14 shows an example of a computer system suitable for carrying out the present invention.

### DESCRIPTION OF PREFERRED EMBODIMENTS OF THE INVENTION

Documents are routinely created and stored using several proprietary word processors, page layout or graphic design applications. This leads to problems in transferring data from one proprietary system to another. However, it is possible to store and represent documents in commonly available non-proprietary formats.

An electronic document can conveniently be represented, stored and/or distributed using a mark-up language. A mark-up language comprises metadata tags (also known as mark-ups) embedded within the document. A tag often provides information about data (which may be text or a picture) which immediately follows that tag. Mark-up languages which are well-known as of September 2004 include HTML and XML. These mark-up languages use text to represent both tags and data. Other mark-up languages may not use only text, and may be more difficult to interpret by a user without processing. Advantages of using a mark-up language, particularly XML, include flexibility to represent a wide variety of documents and data, wide recognition, and the availability of many editors for creating and editing mark-up documents. XML is extensively used for representing, storing and exchanging data, especially over the Internet. The version of the XML specification as of September 2004 is available from the World Wide Web Consortium (W3C) on the Internet

Considering XML in greater detail, an XML document (which is a document compliant with the XML standard) usually comprises a hierarchical arrangement of start tags, end tags and data content. The tags are machine-readable, so a machine can determine information about the document and its data content. This allows the machine to process and/or interpret the document. An XML document generally comprises a plurality of XML elements. An XML element comprises a start tag, an end tag and optionally data content located between the start and end tags. An XML element may also have one or more “child” elements enclosed between its start and end tags. The child elements are hierarchically less significant than the immediately enclosing element which is called the “parent” element of the child elements. The hierarchically most significant element is known as the “root” element, of which there can be only one in a well-formed XML document. The start and end tags of the “root” element define where the document starts and ends, i.e. they define the extent of the document.

An XML element start tag comprises a name of that element enclosed within angled brackets, for example <para> to represent a paragraph. The name can be chosen to indicate the nature of or be descriptive of the contents of that element, although this is not a requirement. An end tag is identical to its associated start tag, with a forward slash character preceding its name, for example </para>. The contents of the element (actual data content and/or child elements) are physically located between its start and end tags. If an element is empty, i.e. it contains no data or child elements, it may be represented by a single empty-element tag instead of separate start and end tags. An empty element tag is identical to a start tag, except that a forward slash character follows the element name, for example <element/>.

An XML start tag or empty-element tag can also contain one or more attributes. An attribute has a name and an associated value, and conveys some information about that element and/or data contained therein. An example of an element start tag having an attribute is <element language=“English”>. In this example, the name of the attribute is “language” and its value is “English”. The name of an attribute can be chosen to be descriptive of the information it conveys. An example of an empty-element tag containing an attribute is <element language=“English”/>.

Many document viewers exist which allow a user to view an XML document in a format that is more user friendly than merely viewing the XML document as a text file. Such viewers include Microsoft Internet Explorer. However because elements which contain data in an XML document can have any name chosen by the document creator, the viewer does not automatically know how the data is intended to be displayed, and so the viewer merely displays a hierarchical tree structure representing the XML document.

In order to allow XML documents to be displayed correctly, XSLT has been developed, the specification of which as of July 2004 can be found at the World Wide Web Consortium (W3C) on the Internet. XSLT is a programming language which transforms an XML document into another XML document, or a document capable of being displayed correctly by an appropriate viewer. For example, XSLT can transform an XML document into HTML for correct display using a web browser. XSLT can also be used to filter data, sort data, add data and/or remove data to/from an XML document. An XSLT program comprises a list of instructions compliant with the XML standard.

There are a number of software programs available which will perform transformations of XML documents using XSLT. These include up-to-date browsers such as Microsoft Internet Explorer. An open source XSLT processor called “Saxon” developed by Micahel Kay

XSL-FO is an XML-based language for describing the appearance of an XML document when it is printed or viewed on a computer screen using suitable viewing software. XSL-FO is sometimes referred to simply as XSL. The XSL-FO specification as of September 2004 can be found at the World Wide Web Consortium (W3C) on the Internet. XSL-FO can be used, among other things, to set the appearance of text when printed or viewed. XSL-FO is often combined with XSLT to provide a program which indicates the appearance of an XML document.

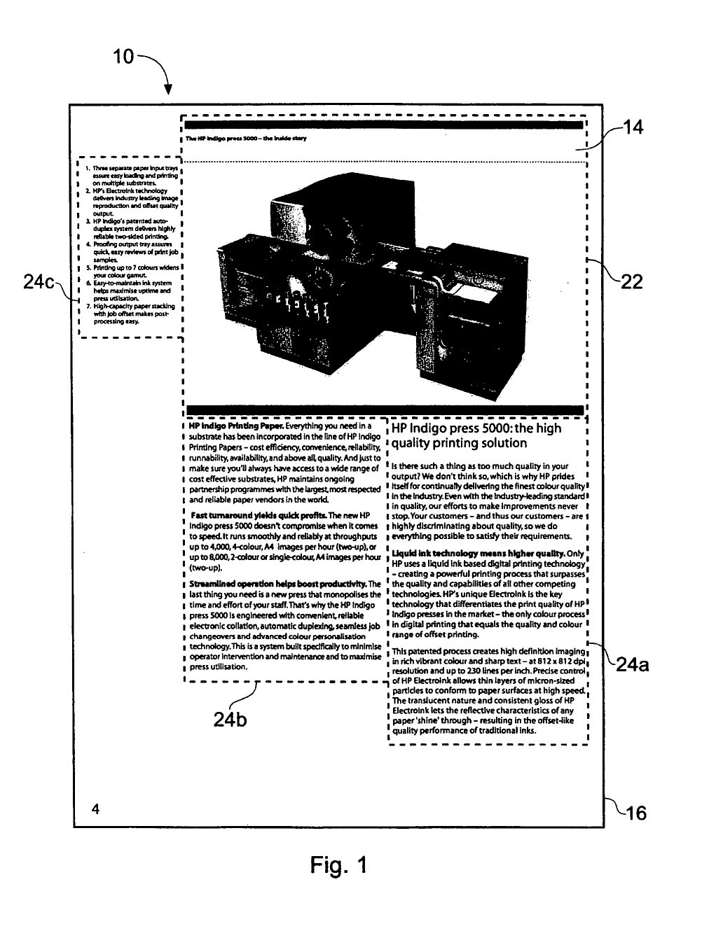

FIG. 1 shows an example of a document 10 which is intended to be printed onto a single A4 page. The document 10 is a magazine article describing a printer. The article includes an image 14 of the printer and a textual description of the printer.

A graphic designer would receive the text content, i.e. description, and the assets (image) from the journalist and arrange them onto a page generally designated 16. The document may span more than one page or may be constrained to cover only a portion of a page. However, for simplicity we will assume that the target medium is in this case an A4 page and consequently the dimensions of the page are known. This allows the graphic designer to fix the various parts of the document on the page 16. However, the present invention can be used where the dimensions of the target medium are not known. This is often the case for web pages, as the resolution of the screen with which a reader views the web page is not known. In this case the graphic designer may have less freedom to fix the various parts in particular positions on the page, or he may fix the dimensions over which the document will appear on the page and thus more reliably control the document's appearance.

The graphic designer arranges the various parts of the document typically using a graphic design software package. Such software packages are widely available as of September 2004 and do not form part of the invention. The graphic designer can define a number of regions (which might also be referred to as frames) on the page 16 into which constituent parts of the document can be inserted. For example, as shown in FIG. 1 the image 14 is placed within a rectangular region 22. The description is divided between three regions 24a to 24c which are arranged to conform with other parts of the document placed on the page 16. The invention is however not concerned with and not restricted to any particular arrangement of parts of the document. The regions 22 and 24a-24c are intended to remain fixed in their size and position when the document is published for printing or display on a user's screen.

When a region 24a-24c is intended to define an area for text, the region is called a “run-around” for the text. The regions do not need to be in the form of rectangles, and they can take any shape. This is particularly useful when for example an image has an irregular shape (or the image is rectangular but the subject in the image has an irregular shape). A run-around for text can be shaped to conform closely with the image (or subject), thus reducing the occurrence of empty spaces in the document. In the prior art, the entirety of the document is saved as a single file by the application used to create and compose the page. This makes it difficult for the work of the graphic designer to be re-used with minimal intervention. Such re-use may, for example, be the republication of the article in a sister publication where the look and feel of the page is maintained but the language is changed.

The present invention seeks to provide a mechanism for facilitation re-use of the time consuming and hence expensive work done by the graphic designer.

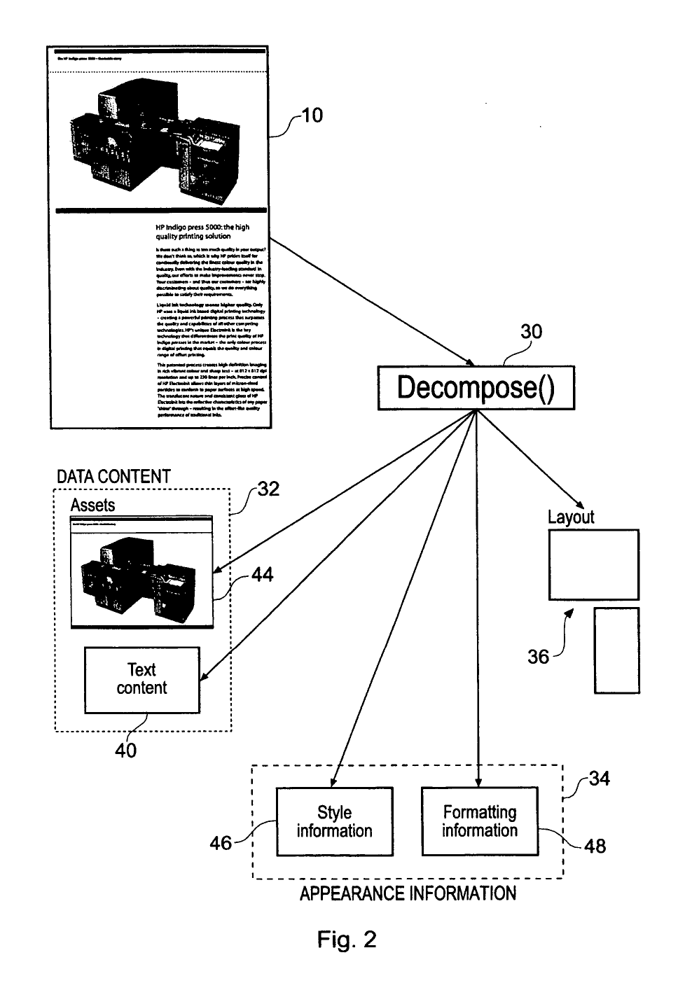

When the graphic designer has finished the arrangement of the parts of the document, the document is decomposed using a decompose process so as to decompose the document 10 into data content 32, appearance information 34 and layout information 36 as shown in FIG. 2. In the presently described embodiment, the data content comprises text content 40, which is the textual content from the document 10, and assets 44. The assets 44 include non-textual content from the document 10 such as images (although the assets 44 could be handled by text processing in alternative embodiments of the invention where assets are represented using text).

The appearance information 34 in the present embodiment comprises style information 46 and formatting information 48. The style information 46 contains a list of styles which are associated with the appearance of text, for example, font, font size, colour and the like. The formatting information specifies which styles should be applied to certain parts of the text content 40 in order to give the text content 40 the appearance of the text in the original document 10. The position of the text on the page is not specified by the style information 46 or the formatting information 48.

The layout information 36 comprises information describing the size, shape and relative position of the regions 22, 24 from the document 10.

Each region described within the layout information 36 may be associated with an asset or the data content or a part thereof. Alternatively a region may be associated with another region. This may be the case where for example the description is intended to span a number of regions. Instead of particular parts of the description being assigned to a particular region, the description may automatically spill into a subsequent region when a first region fills up, and then into further regions and so on.

The specific implementation of representing the layout information 36 (i.e. the form in which it is stored and/or distributed) is not fixed by the invention and the skilled person will envisage or choose from a number of suitable implementations.

The text content 40 comprises the text of the description in the document 10, divided into paragraphs or sections as necessary. The text content does not contain any other information which dictates the appearance or the layout of the text.

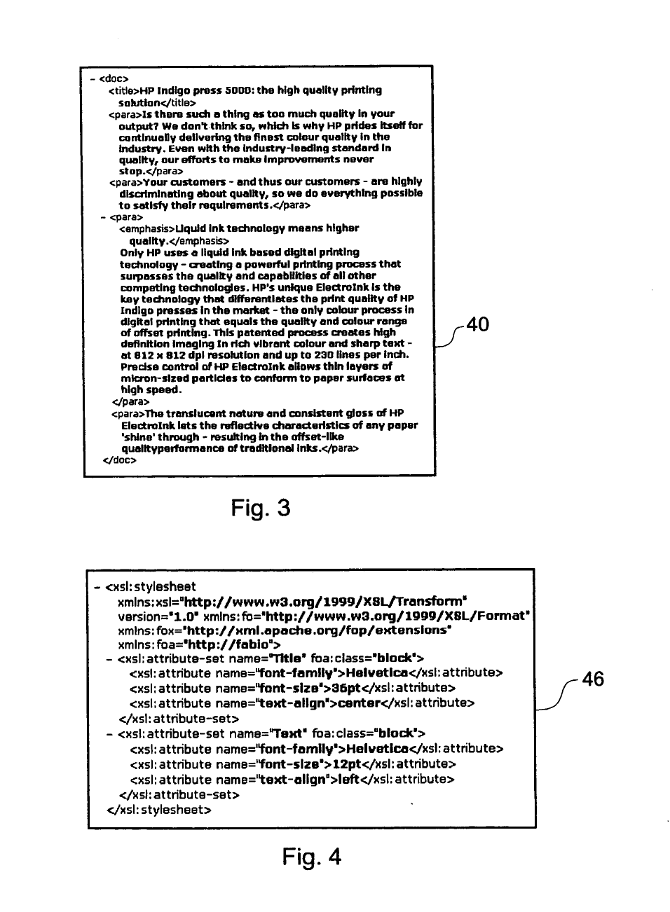

FIG. 3 shows an example of text content 40 taken from the document 10. The text content 40 is represented in an XML-compliant format and the document decomposition process has determined the portions of the text that belong within paragraphs and which represent titles. This may be achieved by intelligent analysis of the image of the document but may also be determined by extracting this information from the document design as held within the graphics design or other application used to create the document. The root element is named “doc”. The title is enclosed within an element named “title”. Paragraphs of the text are contained within “para” XML elements. It will be evident to the skilled person that this representation is not essential and other representations can be used.

FIG. 4 shows an example of style information 46 derived from the document 10. Once again the style information could be derived from analysis of the finalised image but can also be extracted from the representation of the document described by the graphics design application. The style information 46 is represented using XSLT. The style information contains two elements named “xsl:attribute-set”. Each of these defines a style having a name equal to the value of the “name” attribute within the corresponding “xsl:attribute-set” element. Each “xsl:attribute-set” occurring at lines 6 and 11 of FIG. 4 element has one or more child elements named “xsl:attribute”. These have a “name” attribute corresponding to a property of appearance of text used in XSL-T. They also have contents (between the start and end tags) corresponding to the value that the text property (in practice an XML attribute) should take when that style is applied. For example, the example style information 46 in FIG. 4 has a “xsl:attribute-set” element corresponding to a style named “text”. Child “xsl:attribute” elements specify values for “font-family”, “font-size” and “text-align” attributes. These correspond to font, size and alignment of text respectively. The values of these attributes are applied to text having that style.

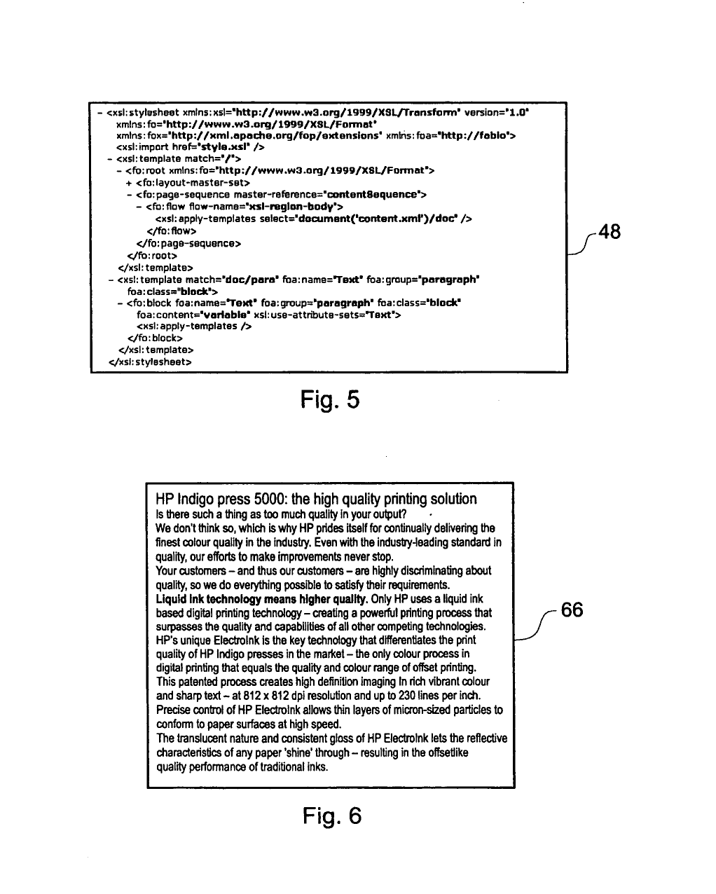

An example of formatting information 48 derived from the document 10 is shown in FIG. 5. This example comprises a mixture of XSLT and XSL-FO formats. The formatting information specifies parts of the text content 40 and which styles from the style information 46 should be applied to those parts. In this example, the style named “Text” should be applied to all of the “para” elements within the example text content 40 of FIG. 6.

The document has thus been split into three major components:
1. The data content
2. The layout of the document; and
3. The appearance of the document.

Within these definitions, the data content can be further divided into text content and assets, whereas the appearance can be divided into formatting information and style information.

The components are now suitable for permanent storage or sending to a recipient. These are the most likely uses of the components however other uses are envisaged, for example the components may be recomposed immediately using a method as described below to finalise the document for printing or display.

When it is desired to finalise the document for printing on to a medium or for display on a viewer's screen, it must be finalised into a form recognisable by printing hardware or software or display hardware or software. An example of finalising a document into a form recognisable by software within a printer is described below. The form is PPML which is recognisable by a number of modem printers as of September 2004.

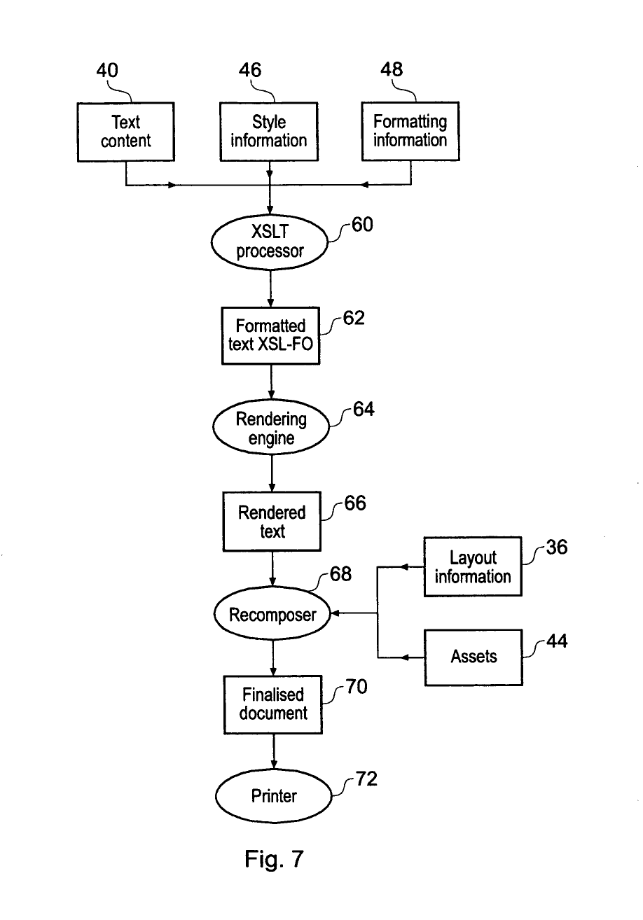

The steps for finalising the document are shown schematically as an example in FIG. 7. The text content 40, style information 46 and formatting information 48 are first processed using an XSLT processor 60 to produce formatted text 62 in XSL-FO format.

The formatted text 62 is then passed to a rendering engine 64 to produce rendered text 66. The format of the rendered text is preferably SVG or PDF format, although any format recognisable by subsequent processes is satisfactory. The appearance of the text within the rendered text 66 is known and fixed. An example of such rendered text 66 is shown in FIG. 6, and contains a title of large size, and bold text in line 8.

A recomposer 68 then takes the rendered text 66, layout information 36 and assets 44 and produces a finalised document 70. The recomposer 68 uses the layout information 36 to arrange the assets 44 and the rendered content 66 onto one or more finalised pages in the finalised pages in the finalised document 70, such that its appearance (when printed) is identical to that provided in the original document 10.

The finalised document 70, in PPML format, can be sent directly to a suitable printer 72 for printing.

In alternative embodiments, the PPML document 70 can be viewed with a suitable viewer on a computer screen, or it can be sent to a recipient for viewing or printing. Other formats for the finalised document 70 can be employed. These include SVG, postscript and PDF which are particularly suited for printing. PDF, HTML and other formats are particularly suited for viewing on a screen. However the majority of formats are suitable for both viewing on a computer screen (for example using a software program for viewing) and printing.

It should be noted that the processing steps shown in FIG. 7 could be modified to execute in a different order to achieve the same result.

The viewed or printed document of the present example will appear substantially identical to the original document 10 shown in FIG. 1. An exception to this could be where the recomposed document 70 is viewed on a display screen having a different resolution to that on which the original document 10 was prepared.

As noted before, it may be desirable to change one of the components of the original document 10 after the document 10 has been completed. For example, the text content 40 may be amended such that a different description appears within the finalised document 70, the style information 46 may be amended so that the text within the finalised document 70 has a different appearance, or the formatting information 48 may be amended such that different formatting and styles are applied to the text in the finalised document 70. Furthermore the assets 44 may be amended so that the finalised document 70 contains different images or other assets.

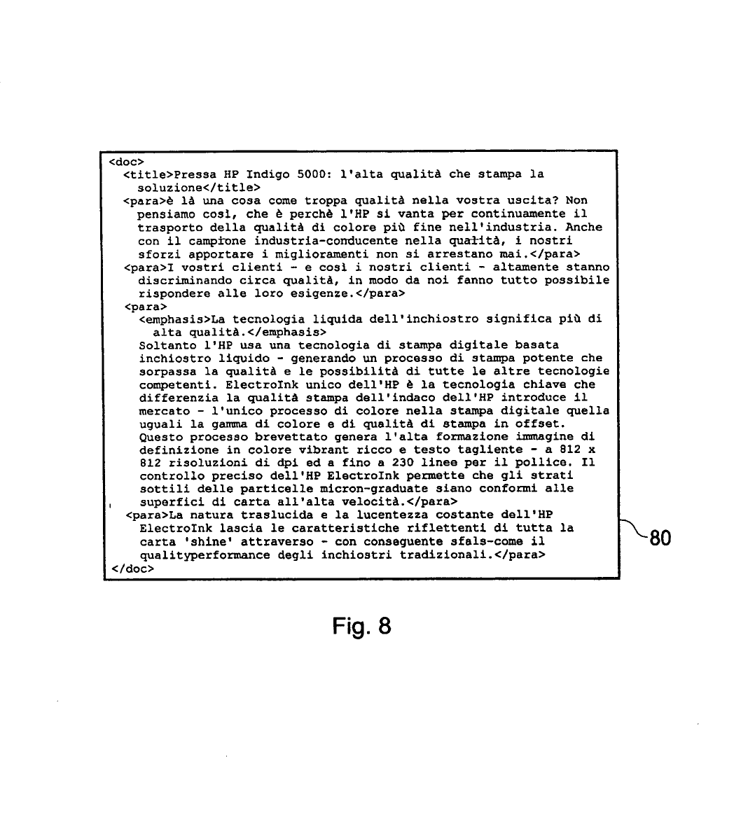

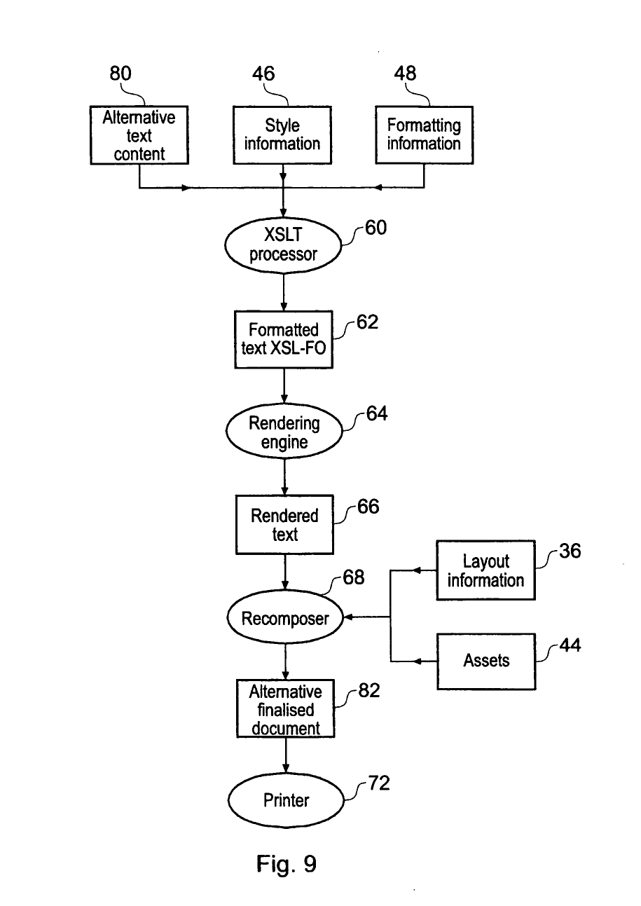

FIG. 8 shows an alternative text content 80, in this case an Italian translation of the English text to be inserted into the finalised document 70 in place of the original text content 40. The alternative text content 80 is XML-compliant and is arranged in a manner identical to that of the original text content 40, e.g. paragraphs of text are enclosed within “para” elements. This is advantageous so that the alternative text can be included within the finalised document with little or no user intervention once the alternative text content 80 has been created. However, the text could have been converted into this format using the decomposition process described with respect to FIG. 2. The process for producing an alternative finalised document 82 is shown schematically in FIG. 9. This process shown in this Figure is identical to that described with reference to FIG. 7, except that the original text content 40 has been replaced with the alternative text content 80, and the alternative finalised document 82 is produced instead of the original finalised document 70. The alternative text content 80 is therefore included within the alternative finalised document 82. The alternative finalised document 82 would have an identical appearance to the original 10 of FIG. 1 (or the appropriate portion thereof), except that the English text has been replaced by the Italian text.

It is thus possible for example for a journalist or editor to amend or replace the description in the original document 10 (or portion thereof), or for a translator to translate the text. A finalised document can then be prepared for viewing or printing, and the appearance (i.e. layout) corresponds to that which has already been determined by the graphic designer for the original document 10. Further input from the graphic designer is not required.

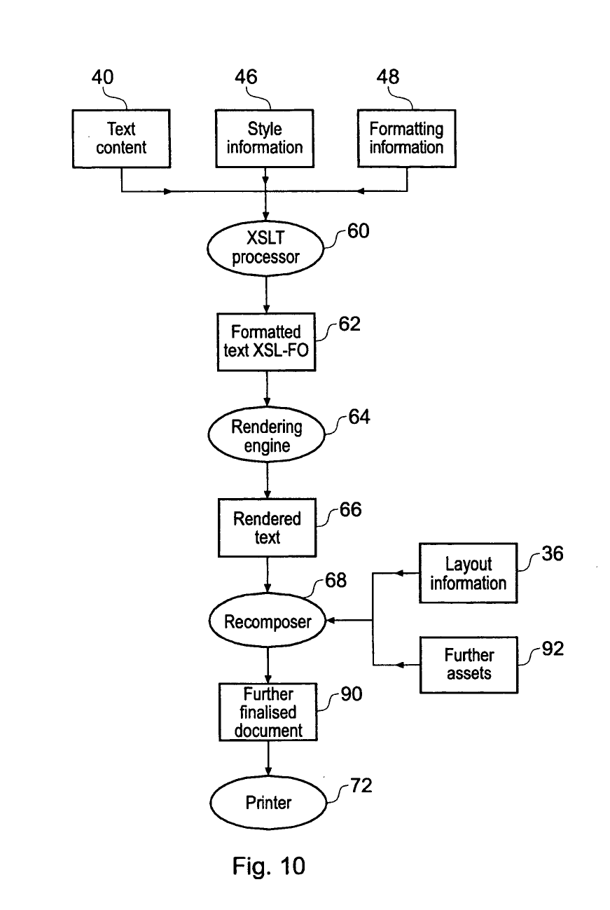

When it is desired to replace one of the assets 44 in the finalised document, for example an image, the alternative image can be incorporated into a further finalised document 90. An example of the process of producing the further finalised document 90 is shown schematically in FIG. 10. This Figure shows a process which is identical to the process described with reference to FIG. 7 except the assets 44 have been replaced by further assets 92, and a further finalised document 90 is created instead of the original finalised document 70. The further assets 92 include a different image 94, in place of the original image 14 (shown in FIG. 1).

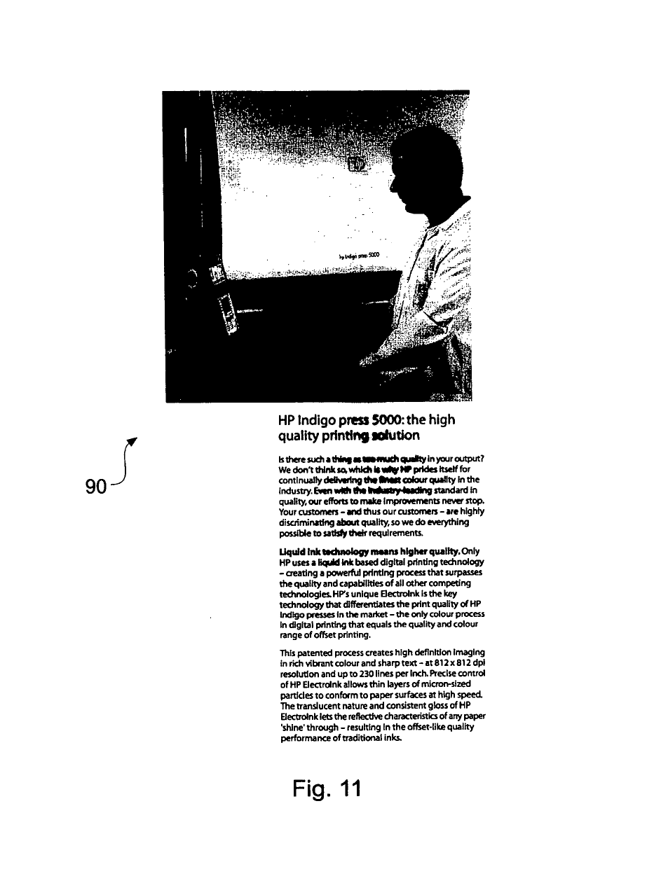

FIG. 11 shows the finalised portion of the document 90. Again the layout is the same and need not be amended to produce an acceptable finalised document.

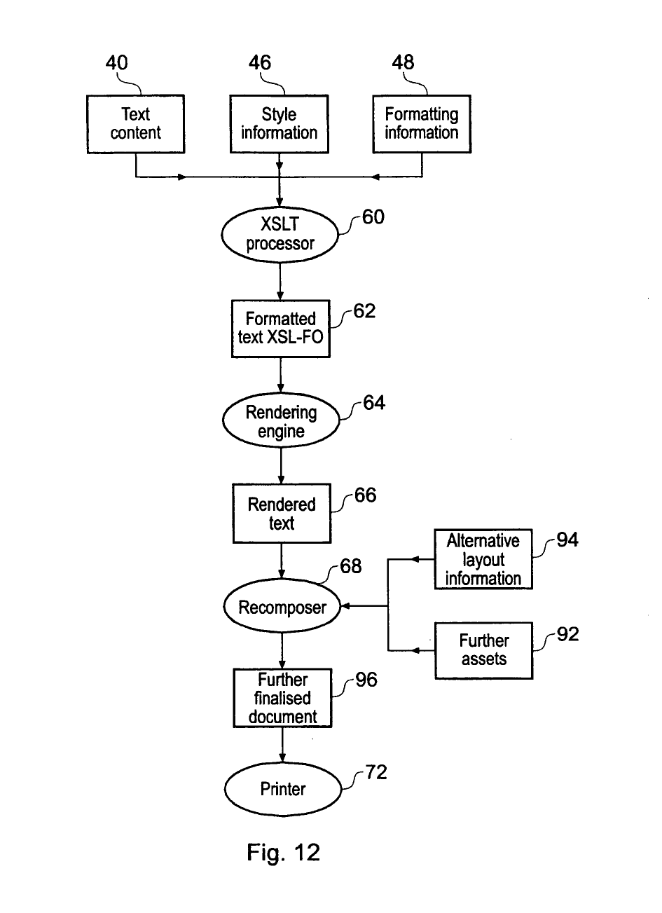

It is also possible to replace the layout information 36 with an alternative layout information 94 before a finalised document is produced. The resulting further finalised document 96 will contain the alternative layout. The process for producing the further finalised document is illustrated in FIG. 12, and is identical to the process described with reference to FIG. 7 except that alternative image 92 is used in place of the original image 44, the alterative layout information 94 is used in place of the original layout information 36, and the further finalised document 96 is produced by the process.

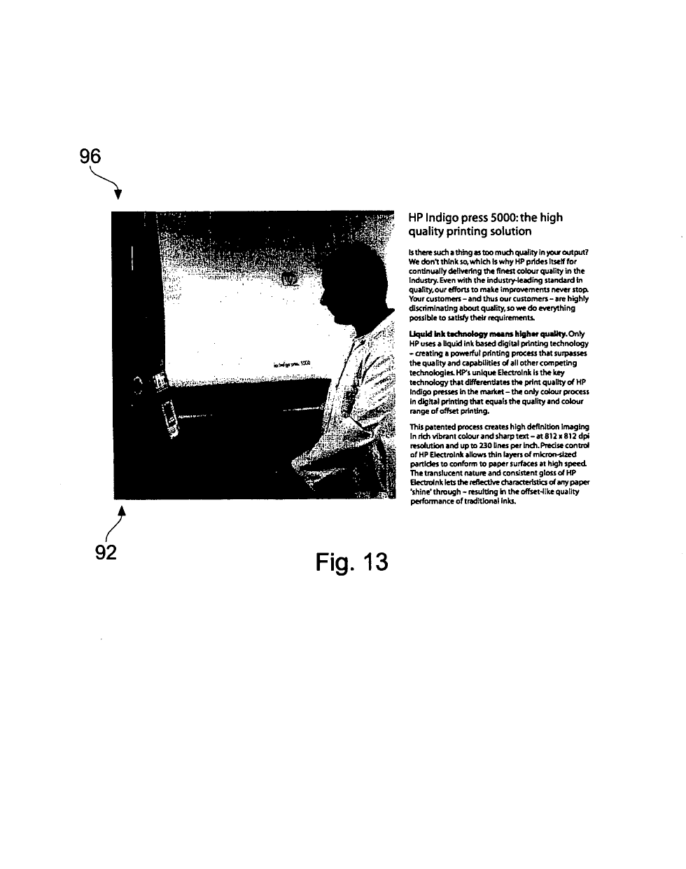

The finalised document 96 is shown in FIG. 13, and has an alternative layout to the portion of the original document 10 shown in FIG. 1.

This example demonstrates that it is possible to amend or replace more that one component which is used in the preparation of a finalised document. It is however not essential that the assets 44 are amended or replaced when the layout information 36 is changed.

It is not essential for the document 10 to be distributed and/or stored in its component form, i.e. with separate text content, style information and so on although this is convenient. At the other extreme, the document 10 may not need to be decomposed at all if it is not amended before being finalised. In this case, when a component is to be amended the document 10 is decomposed, one or more components are amended or replaced as necessary, and the document 10 recomposed. This may occur at any time and need not necessarily be part of a finalising process.

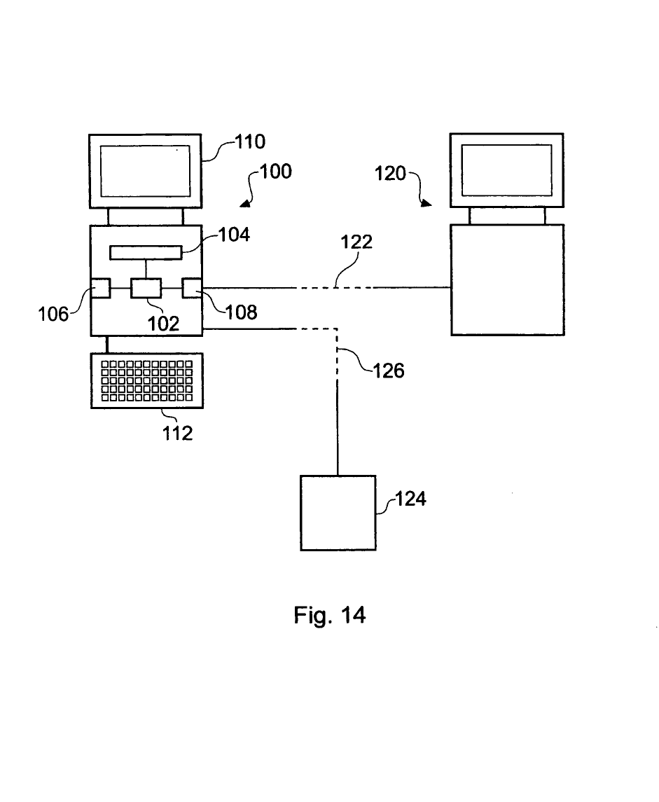

FIG. 14 shows an example of a computer system 100 suitable for carrying out the method according to the invention. The computer system 100 includes a data processor 102 (CPU) in communication with memory (RAM) 104, permanent storage device 106 such as a hard disk, and a communications device 108. The computer system 100 further includes a display device 110 such as a computer screen, and an input device 112 such as a keyboard. A mouse or other pointing device is also provided.

The computer system 100 may be in communication with a second computer system 120 via the communications device 108 and a communications link 122. The communications link 122 may be a wide area network (WAN), local area network (LAN), Internet connection, direct wire link, wireless link or other type of communications link.

The computer system 100 may additionally or alternatively be in communication with a printer 124 via a communications link 126. The communications link 126 may be one of the above mentioned types.

The computer stores and runs an application constituting an embodiment of the present invention allowing a completed page or document to be decomposed into its component parts, one or more of the component parts to be modified and then recomposed, altered if necessary, and used to create instructions for driving a printer.

In general, a user may wish to process documents in a batch. In order to achieve this it is beneficial to be able to define a target data document, target style, layout and format data, and the name and format of an output file. Such information might be represented as:

| DATA | STYLE | LAYOUT | FORMAT | OUTPUT |
|---|---|---|---|---|
| Article1-EN | S1 | L1 | F1 | Art1-EN-PPML |
| Article1-FR | S1 | L1 | F1 | Art1-FR-PPML |
| Article2-EN | S1 | L2 | F2 | Art2-EN-PPML |

The data processor would read the data file “Article-EN” and apply the style S1, layout L1 and format F1 to it to produce an output file Art1-EN-PPLM suitable for printing. In this example “EN” indicates the article was written in English. If a publisher wants to create a French version from a translated text “Article 1-FR”, then they can specify, at line 2, that Article1-FR” is to be used as the data file, and S1, L1 AND F1 are to be applied to it, and the result output as “Art1-FR-PPML”. The publisher might also wish to process a second source text “article2-EN” using the same style S1, but different layout L2 and format F2, the results being written to a file Art2-EN-PPML.

The instruction table may be created as an edited document or built using a GUI.

It is thus possible to provide for automated decomposition of documents into component parts and automated composition of documents from component parts.

Although the data, formatting information and layout information have been described as being in separate files, it is possible to save them in a single file provided that these components are distinguishable from one another.

1) A method of preparing a document for distribution, display or printing, where the document is defined by:
data content;
appearance information defining an appearance to be applied to the data content; and
layout information defining a layout to be applied to the data content; and
where the data content is distinct from the layout information and the appearance information, the method comprising an input step where the data content, appearance information and layout information are made available to a data processor, and a processing step where the appearance information and layout information are applied to the data content so as to produce an electronic representation of the document.

2) A method as claimed in claim 1, in which the appearance information comprises style information and formatting information, and the style information is distinct from the formatting information.

3) A method as claimed in claim 2, in which the style information is in XSLT format.

4) A method as claimed in claim 2, in which the formatting information is in one or more of XSLT and XSL-FO formats.

5) A method as claimed in claim 1, in which at least one of the data content and the layout information is XML-compliant.

6) A method as claimed in claim 1, in which the document for display or printing is XML-compliant or is produced in one of PPML, SVG and XML-FO format.

7) A method as claimed in claim 1, in which the data content and the layout information are available as separate items.

8) A method as claimed in claim 1, wherein the method further includes the step of reading the data content from at least one data content file.

9) A method as claimed in claim 1, wherein the method further includes the step of reading the layout information from at least one layout information file.

10) A method as claimed in claim 1, in which the method further includes reading the appearance information from at least one appearance information file.

11) A method as claimed in claim 1, further including the step of outputting the electronic representation of the document.

12) A method as claimed in claim 1, further comprising the step of defining a list of data content files to be processed such that multiple documents can be produced automatically.

13) A method as claimed in claim 12, further including a step of defining the layout data and appearance data to be associated with a given data content file.

14) An apparatus configured to prepare a document for distribution, display or printing, wherein the document is defined by:
data content;
appearance information defining an appearance to be applied to the data content; and
layout information defining a layout to be applied to the data content, wherein the apparatus comprises a data processor arranged to receive the data content, the appearance information and the layout information, and to apply the layout information so as to produce an electronic representation of the document.

15) A apparatus as claimed in claim 14, in which the apparatus is arranged to read style information from a style file and read formatting information from a format file, wherein the style information and the formatting information collectively define the appearance information.

16) An apparatus as claimed in claim 14, in which the apparatus is arranged to output the electronic representation of the document.

17) An apparatus as claimed in claim 14, in which the apparatus is responsive to a process list specifying a plurality of data content files to be processed.

18) A method of storing a document, comprising the steps of storing data content of the document in a data file, and storing information relating to layout of the data content in a layout file and storing information relating to the appearance of the data content in at least one appearance information file.

19) A method of storing a document as claimed in claim 18, wherein the step of storing information relating to the appearance comprises storing style information in a style file and storing formatting information in a format file.

20) A method of parsing a document comprising the steps of:
a) reading an electronic representation of a document;
b) processing the document so as to identify the textual content of the document and saving the textual content of the document to a data file;
c) processing the document so as to identify layout information and saving the layout information to a layout file; and
d) processing the document so as to identify appearance information and saving the appearance information to at least one appearance information file.

21) A computer program for causing a programmable data processor to implement the method defined in claim 1.
